(19) United States
(12) Patent Application Publication
(10) Pub. No.: US 2002/0117845 A1
(43) Pub. Date: Aug. 29, 2002

(54) Security and/or valve document

(75) Inventors: Benedikt H. Ahlers, Berlin (DE); Frank Kappe, Berlin (DE); Roland Gutmann, Berlin (DE); Ralf Paugstadt, Berlin (DE); Armim Franz-Burgholz, Berlin (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: BUNDESDRUCKEREI GMBH, BERLIN (DE)

(21) Appl. No.: 10/060,372

(22) Filed: Feb. 1, 2002

Related U.S. Application Data
(63) Continuation of application No. 09/476,203, filed on Jan. 3, 2000, now abandoned.

(51) Int. Cl. B42D 15/00

(52) U.S. Cl. 283/72

(57) ABSTRACT

The present invention relates to a security document and/or value document, in particular banknote, with security features and with a verification element for verifying the security feature.

The object of the present invention, to develop a generically compliant security document and/or value document, in which security against forgery is increased and the document can be inspected for genuinity more easily and without the use of external aids, is accomplished in that at least one verification element 2 and at least one security feature 3 to be verifiable by this verification element 2 are integrated into the document 1 in various positions, whereby the verification element 2 and the security element 3 are brought over each other only when verification is to take place.

With these products it is desirable to incorporate features that facilitate providing evidence of their genuineness, i.e. that show that they are originals.

These security features should preferably be fixed in an inseparable manner to the product that is to be authorized and/or they should have features that are difficult to reproduce.

The background of the invention is the manufacture and application of security features for security documents and/or value documents.

Numerous security features are known, such as fluorescing fibres or threads/planchettes/colours, microtypes, moiré-generating structures, holograms and similar.

Frequently, the security features implemented in products requiring protection consist of special colours having special spectral characteristics or magnetic properties or temperature-dependent behaviour (thermochrome colours). Barcode is used, in which the difference in reflectivity of the surface is utilized, or grid structures or film antennae utilizing the resonance frequency in an oscillating circuit are also put to use.

Security documents are known from AU 488 652, where the security features can be inspected by means of through-light viewing. Arranged between plastic webs, there is an optically varying security element, which can be viewed through a transparent window located in the above-lying cover web. The disadvantage here, in particular, is that with the naked eye the applied security features can only be viewed through-light, and that the material properties of the document are severely altered.

The implementation of only one transparent window on banknotes is also known as a security feature applied in practice (Australian banknotes).

DE 43 34 847 A1 describes a value document with a window where the base material is subsequently given a window-like knock-out, which is then covered by a transparent cover film, whereby the cover film in this part of the window incorporates additional security features. The process of manufacturing this subsequent break-out in the base material of the value document (security), to provide a window, and then covering this window with a cover film that partly incorporates additional security features, is technologically intensive and means that the material of the value document is made thicker. The requirement, that parts of the window must remain transparent so that the security features can be viewed through-light with the naked eye, limit the possibilities offered of providing security features arranged in a covered form. Just as with the known window threads used on banknotes, such possibilities involve elements which, in themselves, only serve as a security element but have no further function. These known windows may themselves also incorporate security features.

The test for genuinity of the known security elements usually requires the application of special equipment, methods and, in particular, test equipment such as magnifying glasses for checking microtype, lenticular screens for checking hidden graphical elements, UV lamps for making fluorescences visible, or a through-light method for optically recognizing the respective security feature.

DE 36 09 090 A1 describes a value document (security) into which a security thread has been deposited, which can be viewed visually without a technical aid. The security thread consists of a transparent material. Impressed into the upper surface is a screen of cylindrical lenses. Applied directly to the opposite side of the film of the foil there is a printed image. This printed image is designed with consideration to the optical characteristics of the cylindrical lenses. By designing the printed image accordingly, it is possible to incorporate information here that only becomes visible from certain viewing angles.

A disadvantage here is that there is paper arranged directly beneath the thread, so that the security feature can only be viewed through reflection and not through transmission. Only the thread provides the element of security. The thread constitutes a conventional security element.

The object of the present invention is to develop a generically compliant security document and/or value document, in which security against forgery is increased and the document can be inspected for genuinity more easily and without the use of external aids.

The object of the invention is achieved through the characteristics defined in Claim 1. By implementing on the document both security features as well as verification means, such as detectors for verifying these security means, what is accomplished is that no external means for checking the genuinity of the document are required. The authenticity of security features on a document, for example a banknote, can be checked by means of one or more transparent windows on the same banknote. The combination of security features and a verification system on one and the same banknote increases security against forgery, because the verification means can in itself also be designed as a security feature. Both the viewing side and the rear side of the banknote can be viewed to check authenticity. By suitably folding a banknote, or any other document that has been manufactured in accordance with the method of the invention, or by stacking several banknotes on top of each other, it is possible to check the security feature by bringing the security feature into interaction with the verification system, e.g. window.

A verification element that has been applied to the value document can be used to check different security elements incorporated at different positions in the value document.

For example, in a passport two opposing pages can be used to verify the document. For this purpose, one of the pages can be fitted with the verification element, e.g. a lenticular screen film, on part or all of the page, while the other page may have the security feature that must be analyzed, for example a latently visible screen structure. The genuinity of the document is checked by suitably placing these two pages over each other. Similarly, two banknotes, checks or two other equivalent value documents can be checked for genuinity.

The decisive factor is the functionality of the window or windows integrated in the document. No substantial thickness is added to the document, because the security feature and the detection means are located on different parts of the document and not over each other.

The preferred embodiment of the verification element as a detector/analyzer or also a decoder in the form of one or several transparent windows, or also as a window with several analyzer areas with detection elements, ensures a multitude of different variations for testing the genuinity of a large number of possible security features.

Preferably, the verification elements on/in one window or on/in several windows or sections of a window are formed of clear, transparent material and are preferably formed out of one of the following groups:

1. The verification elements are formed by lenticular lenses/cylindrical lenses/alternating images and autostereoscopic devices, which are located on/in a transparent film or similar; they make the optically coded security features or the structures printed on the document visible.

The lens screens preferably consist of equal-type cylindrical lenses, which are arranged parallel to each other, preferably at the same distance apart (e.g. 200 μm). Preferably, the focus of such a lens screen will be adjusted to match the optical thickness of the transparent substrate material used.

These cylindrical lenses can be introduced into the transparent material, e.g. PVC films, by several different means, e.g. by paging with a suitable master, or they can also be produced by casting the film in a suitable form or they can be introduced into the film by extrusion, using specially formed injection nozzles.

2. The verification elements are formed by using Fresnel lenses or other similar magnifying optical structures, which facilitate the detection of very fine print or very small graphics on the respective document.

3. The verification elements are formed by preferably printed fine graphical structures that are applied to both the film of a window as well as to part of the document.

The window forms the mask for a “parallax-barrier display”.

When the corresponding surfaces (window/security feature on the document) are placed on top of each other, so-called moiré structures are generated. Together with the line or dot screens in the area of the security feature on the document, the line or dot screens on the window form such a moiré structure. The moiré pattern thus formed is the characteristic security feature for the respective value document.

When the windows are arranged in such a manner that they are placed on top of each other when the document is folded, exactly register-true structures will create colour or pattern changes when the two surfaces are moved relatively to each other.

4. The verification elements are formed with polarizing filters.

In the preferred embodiment, two clear windows are arranged adjacently or a window is divided into two analyzer areas.

The windows can be embodied as two polarizers for viewing polarisation stereo images.

It can be accomplished, that at least one specially formed window forms a “Polaroid-Vectograph”.

Windows can be formed in such a way that a switch in contrast from transmitting to opaque can be implemented. Such structures can be implemented by means of half-wave zones, which are applied to a linearly polarizing film, for example by suitably oriented films of correct thickness:

The bright and dark areas of an image are linearly polarizing areas with alternating horizontal and vertical polarising directions.

Windows can be formed, that implement a clear switch in colour based on the “colour shutter” principle.

5. The window is embodied as an interference filter/colour filter (transparent diffraction structures, multilayer systems).

The transparent window is embodied as a holographic filter that reflects a narrow spectral range, either

analogous to holographic laser-protection goggles, or

a compound colour appears in a different colour,

a pure spectral colour disappears.

Such a filter is also suitable for two clear windows, whereby the verification window may be subdivided into a holographic part and a non-filtering adjacent part.

The windows are embodied as two colour filters for viewing anaglyphs (stereo images) or as prisms, preferably as gradient-index prisms (superchromatic where possible), for a chromastereoscopic image.

Further advantageous embodiments of the present invention will become apparent from the sub-claims.

The invention will be described further with the help of the drawings described below; these show embodiment examples of a banknote serving as a value document. In these drawings:

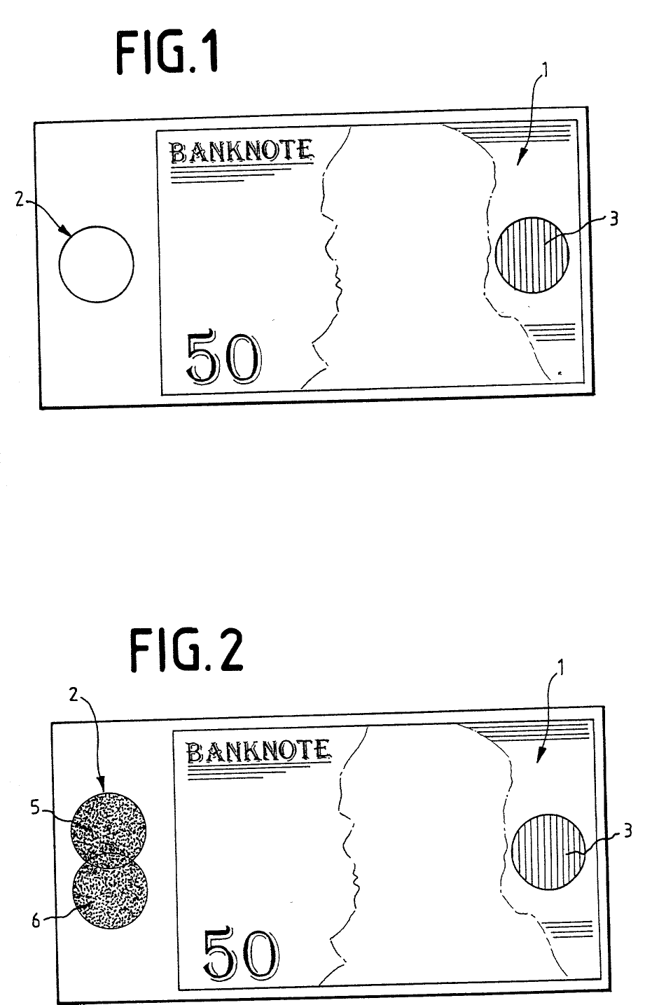

FIG. 1 is a schematic representation of a banknote with a window and a security feature,

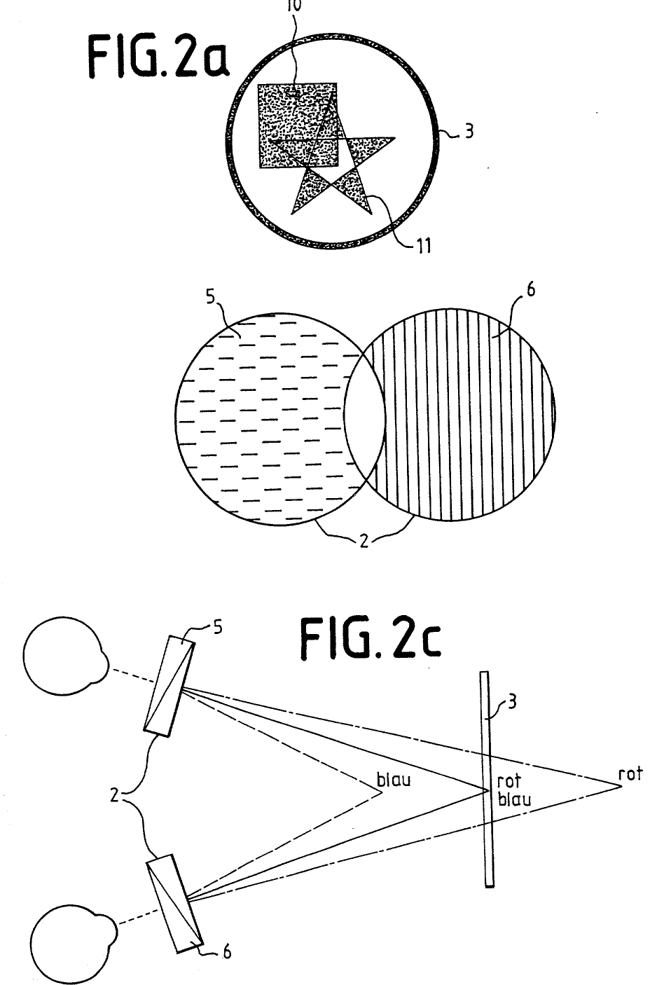

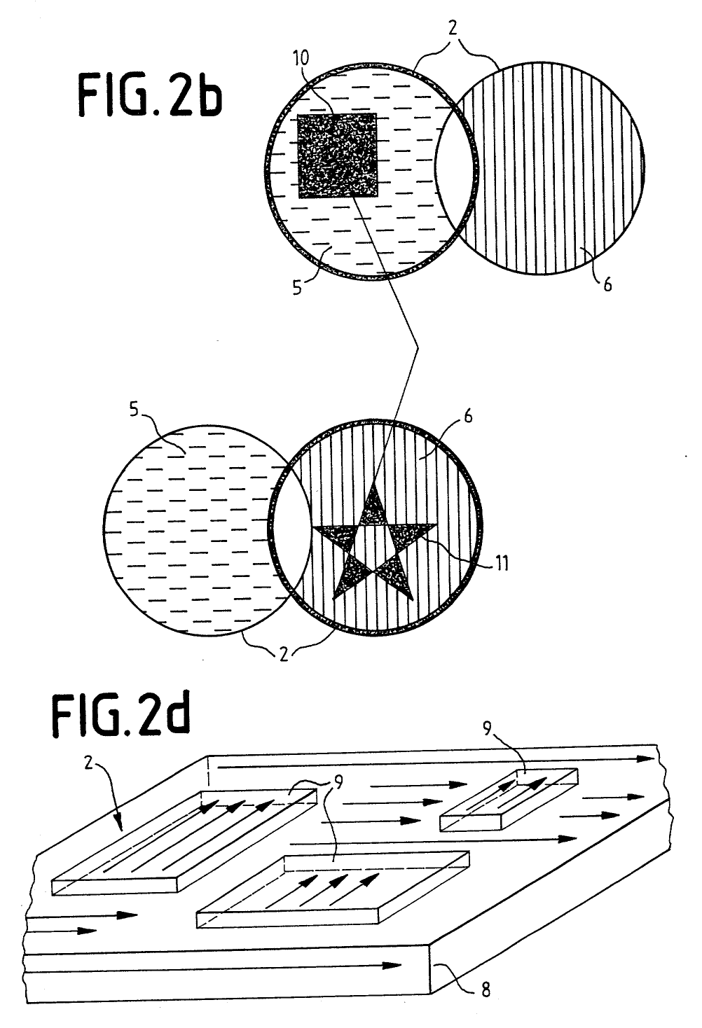

FIG. 2 is the schematic representation of an arrangement with a window having two zones on the banknote and serving as the verification element,

FIG. 2a is the schematic representation of an arrangement of one window with two zones according to FIG. 2, for forming a “Vectograph”,

FIG. 2b is the schematic representation of an arrangement of one window with two zones according to FIG. 2, for forming different patterns,

FIG. 2c is the schematic representation of an arrangement of one window with two zones according to FIG. 2, for forming a chromastereoscopic image,

FIG. 2d is the schematic representation of an arrangement of one window with two zones according to FIG. 2, for forming “half-wave” zones,

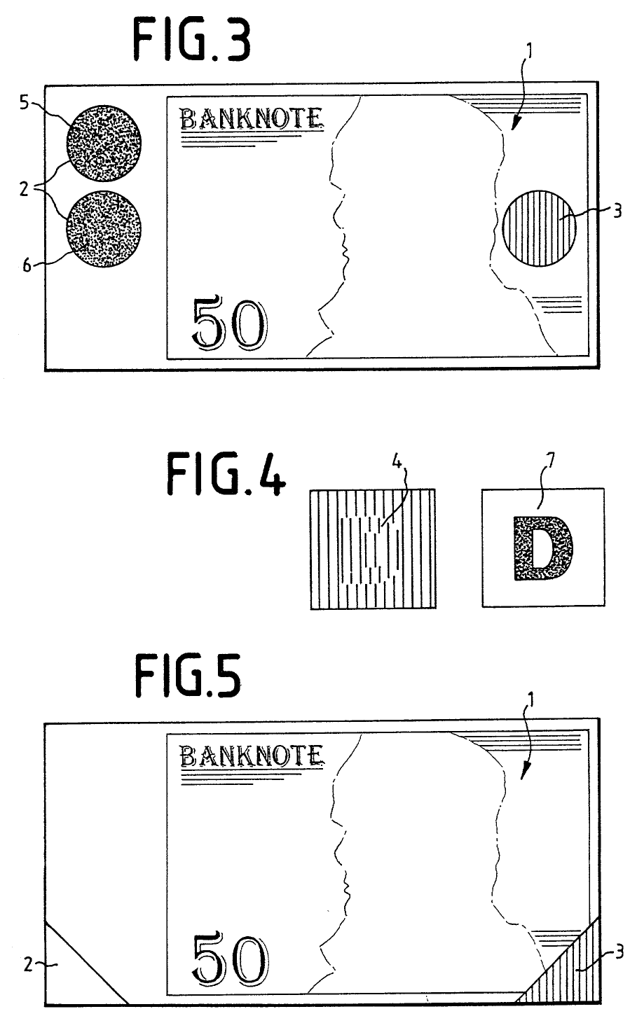

FIG. 3 is the schematic representation of an arrangement of two adjacent windows with different verification elements,

FIG. 4 is the schematic representation of the creation of screen structures, and

FIG. 5 is the schematic representation of a banknote with windows in one corner.

According to the representation in FIG. 1, a value document, e.g. a banknote 1, is embodied with one transparent window 2, which, by means of its being equipped with verification elements serving as a detector or similar, is used to verify a security feature located in zone 3 of the banknote 1. Verification of the security feature in zone 3 of the banknote 1 is accomplished, for example, by overlapping the two zones 2 and 3.

In the first embodiment example, the window 2 in FIG. 1 is provided with a lenticular screen that serves as a verification element. The orientation of the lens screen in the zone of the window 2 and the correspondingly printed screen, which serves as a security feature in zone 3 of the banknote 1, must be co-ordinated in such a way that the required effects become visible when zones 2 and 3 are brought to overlap each other suitably, for example by folding.

The printed screen structures serving as the security feature in zone 3 can be created with any type of printing technique that is applied in security printing, preferably the simultaneous-offset method (Letterset), because of the high resolution required.

FIG. 4 shows a simple example of the creation of screen structures in the form of the letter “D”. By overlapping the lens screen in window 2 with the line screen 4 in zone 3, a clear image 7 of the letter “D” appears in the eye of the beholder.

Also, printed line structures in combination with embossments, which show so-called tilt effects (DE 23 34 702), and which are preferably created using the intaglio process, can be made visible by suitably overlapping zones 2 and 3 (FIG. 1) of the banknote 1, whereby zone 2 must have the lens screen to enhance the tilt effect.

The lens screens preferably consist of equal-type cylindrical lenses, which are arranged parallel to each other, preferably at the same distance apart (e.g. 200 μm).

These cylindrical lenses can be introduced into a transparent material, e.g. PVC films, by several different means, e.g. by casting a film on a belt with a negatively formed profile or by extruding lens screens by means of specially formed injection nozzles, e.g. wide-slit nozzles.

The cylindrical lenses can also be produced by paging with a suitable pattern, or by rolling out films between rollers that have the corresponding negative profile. Gradient-index lenses can be made out of bleached silver halide layers or photo-polymers.

In a second embodiment example according to FIG. 1, the verification element in window 2 of banknote 1 is formed through Fresnel lenses or by means of similar magnifying optical structures that facilitate the recognition of very small type or graphical elements in zone 3 of document 1 when zones 2 and 3 are suitably overlapped. Here the very minimal thickness of the Fresnel lenses together with the good magnification of the lens, e.g. 5 to 10-fold, is a decisive advantage for integration into the substrate materials.

According to a third embodiment example, the verification element in window 2 of the banknote 1 in FIG. 1 is formed by fine line structures, which are also formed on a part of document 1 in zone 3. When the corresponding zones 2 and 3 of document 1 are overlapped, so-called moiré structures are generated. Examples of moiré-generating patterns are described in DE 28 19 640, DE 23 24 702, DE 26 03 558, DE 36 02 563.

The verification element in window 2 may consist of a printed line screen or a printed dot screen for a visual coding/decoding method for a banknote 1. In addition to printing fine dots and/or lines, it is also possible to punch zone 2 (window) of the document 1 or to perforate it, preferably by means of laser perforation, so that suitable overlapping of zones 2 and 3 of the banknote 1, e.g. by folding, will generate a moire pattern. Zone 3 of the banknote 1 may consist of a transparent material with printed lines/screen, an opaque material with printed lines/screen or also a zone with a suitable perforation, preferably a laser perforation.

In a fourth embodiment example, a polarizing filter on/in a preferably transparent film material is integrated as a verification element in zone 2, e.g. of a banknote 1, in combination with a further similarly designed polarizing filter in zone 3. The polarizing filter in zone 3 is preferably designed vertically or parallel to the polarizing filter in zone 2 and works as an analyzer, so that suitable overlapping of zones 2 and 3 of the banknote 1 and rotation of the overlapping zones 2 and 3 against each other will cause the optical transparency (bright/dark) to alternate or change.

In a further embodiment, an additional dichroic (double refracting), graphically structured layer is applied, e.g. by printing, sputtering, casting and similar, so that suitable overlapping of zones 2 and 3 of the banknote 1 and rotation of the overlapping zones 2 and 3 against each other will cause a graphic element, e.g. a letter, to become visible.

A further embodiment is achieved when one of the two polarisation filters in zones 2, 3 is replaced with a reflecting layer, whereby additionally a dichroic, graphically structured layer is applied to this reflecting layer. Suitable overlapping of zones 2 and 3 of the banknote 1 and rotation of the overlapping zones 2 and 3 against each other will cause a graphic element, e.g. a letter, to become visible.

A further embodiment provides that one of the two polarisation filters is replaced with a reflecting layer, whereby additionally a dichroic, graphically structured layer is applied to this reflecting layer. This double-refracting transparent layer can be preferably designed as a liquid-crystal-containing film. Suitable overlapping of zones 2 and 3 of the banknote 1, e.g. by folding, and by rotation of the overlapping zones against each other will cause a graphic element, e.g. a letter, to become visible.

For many verification effects it is desirable to easily and simply bring two different verification elements over the security feature. This often eases the perception of changes in the case of movement-effects or colour-switching effects. It eases verification in cases where a rotation of the verification element with respect to the security feature is necessary. With a single verification window 2, such a rotation would be very impracticable. To solve these problems, it has been suggested that the verification window 2 should be divided into two adjacent analyzer areas (FIGS. 2, 2a through 2d) or that two adjacent windows 2 (FIG. 3) should be arranged with different verification elements.

FIG. 2c shows the embodiment of a window 2 serving as a verification element, where at least two clear analyzer zones 5, 6 are arranged adjacently as windows 2 serving as verification elements on the banknote 1. The analyzer zones 5, 6 are preferably holographic prisms, if possible embodied as superchromatic prisms, for a so-called chromastereoscopic image. Preferably the prisms are embodied as gradient-index prisms in the form of thin film materials.

An embodiment according to FIG. 2a provides that at least two adjacently arranged clear analyzer zones 5, 6 in a window 2 are embodied as a so-called “Vectograph”. A Vectograph consists of two polyvinyl-alcohol films, which form linear polarizing filters when they are printed on with iodine paints. The two films are arranged in such a way that when the front side contacts the iodine paint vertical polarization results, and when the rear side contacts the iodine paint horizontal polarization results (FIGS. 2a, 2b). Iodine paint is used to print a selected first pattern, for example a square 10 (FIGS. 2a, 2b), on the front side, and a selected second pattern, for example a star 11 (FIGS. 2a, 2b), on the rear side. When the two superimposed films are viewed with a linear analyzer (window 2, zone 5 in FIGS. 2a, 2b), the first pattern (square 10) becomes visible when the analyzer is oriented horizontally 5, and the second pattern (star 11) becomes visible when the analyzer is oriented vertically 6. In the same manner is also possible to implement colour changes.

A verification window 2 divided in this manner with analyzer zones 5, 6 makes it unnecessary to have to rotate the window 2; the window 2 only needs to be shifted.

Similarly formed zones 5, 6 can be designed to implement a changeover in contrast from transmitting to non-transparent. Such structures can be implemented by applying to a linear polarizing film 8 (FIG. 2d) so-called “half-wave” zones 9 (phase plates with a phase shift of 180° between the ordinary ray and the extraordinary ray), for example by means of suitably oriented film materials of the correct thickness (FIG. 2d). The polarization direction is turned by 90° in these zones. This effect is particularly impressive with area-filling patterns. Similarly formed build-ups serve to implement a clearly discernible colour switchover based on the principle referred to as “colour shutter”.

In a further embodiment of the verification element(s) in window 2 of the banknote 1, interference filters/colour filters, generally transparent refraction structures and multilayer systems are used.

The interference filters/colour filters are formed in/on the preferably transparent film material or they consist of this material. The filters are integrated for example on a banknote 1 in zone 2 in combination with a coloured graphical element in zone 3. When zones 2, 3 of the banknote 1 are suitably overlapped, a certain spectral range in the graphic element, for example a character, is blanked out by zone 2 or allowed to pass through, so that a colour impression is perceived that differs from the original colour.

Both dyed, transparent materials as well as transparent materials with e.g. coloured vaporized/sputtered, printed colours can be used as interference filters/colour filters.

In a further embodiment, at least two clear analyzer areas 5, 6 are arranged adjacently according to the representation shown in FIGS. 2 and 3. These zones 5, 6 are formed to at least two colour filters for viewing so-called anaglyphs (stereo images), whereby the anaglyphs are located in zone 3 of the banknote 1. When zones 5, 6 and 3 are suitably overlapped in a certain distance to each other, a stereo-impression is created.

All windows can be embodied in any arbitrary form, preferably in a form that is best suited to the respective selected verification element; thus the embodiment can also be thread-like or, as shown in FIG. 5, triangular in shape.

The windows can be embodied at any points on the document, thus also in a corner of the document, as shown in FIG. 5 as an example; the requirement is only that it must be possible to bring together the security feature and the verification element for verifying the security feature in such a way that they can work together, for example by folding, twisting, superimposing one or several documents.

Superimposition can be accomplished by direct contact or, in some cases, with a gap between the security feature and the verification element.

### DRAWING REFERENCE LIST

1 Value document/banknote

2 Zone (window/verifier)

3 Zone (safety feature)

4 Line screen

5 Analyzer zone

6 Analyzer zone

7 Image

8 Polarization film

9 Half-wave zone

10 Square

11 Star

1. Security document and/or value document, in particular banknote, with security features and with a verification element for verifying the security feature, characterized by, that
at least one verification element (2) and at least one security feature (3) to be verified by this verification element (2) are integrated in the document (1) at different positions, whereby the verification element (2) and the security feature (3) are only superimposed when verification takes place.

2. Security document and/or value document according to claim 1, characterized by, that at least one security feature (3) is embodied on the front side and/or rear side.

3. Security document and/or value document according to claim 1, characterized by, that the security feature (3) is formed by at least one window.

4. Security document and/or value document according to claim 1, characterized by, that at least one verification element (2) is embodied on the front side and/or rear side.

5. Security document and/or value document according to claim 4, characterized by, that the verification element (2) is formed by at least one window.

6. Security document and/or value document according to claim 4, characterized by, that the verification element (2) is embodied as a strip on one of the edges of the document (1).

7. Security document and/or value document according to claim 4, characterized by, that one corner of the document (1) is embodied as a verification element (2).

8. Security document and/or value document according to claim 5, characterized by, that the verification element (2) is formed by at least one window with at least one transparent zone and with verification elements such as lenses, graphical elements, polarization filters, colour filters, interference filters, holograms, perforated zones.

9. Security document and/or value document according to claim 8, characterized by, that the verification element (2) is formed by at least one window with at two zones (5, 6) with verification elements.

10. Security document and/or value document according to claim 8, characterized by, that the lenses are lenticular lenses/cylindrical lenses or Fresnel lenses or gradient-index lenses.

11. Security document and/or value document according to claim 8, characterized by, that the window (2) forms a mask for a parallax-barrier display.

12. Security document and/or value document according to claim 8 , characterized by, that the window (2) forms a line screen or a dot screen for a visual decoding method with lines or dots.

13. Security document and/or value document according to claim 8, characterized by, that at least one window (2) is embodied as a holographic filter that reflects a narrow spectral range.

14. Security document and/or value document according to claim 9, characterized by, that the verification window (2) is adjacently subdivided into a holographic zone and a non-filtering zone (5, 6).

15. Security document and/or value document according to claim 9, characterized by, that the verification window (2) is adjacently embodied as tw o colour-filter zones (5, 6) for viewing anaglyphs.

16. Security document and/or value document according to claim 9, characterized by, that the verification window (2) is adjacently embodied as zones (5, 6) with prisms for a chromastereoscopic image, in particular with gradient-index prisms.

17. Security document and/or value document according to claim 9, characterized by, that the verification window (2) comprises a mask for a safety feature (3) for creating a parallax-barrier display.

18. Security document and/or value document according to claim 9, characterized by, that the verification window (2) is adjacently embodied as two zones (5, 6) with polarizers for viewing polarization stereo images.

19. Security document and/or value document according to claim 9, characterized by, that the zones (5, 6) of the verification window form a Vectograph.

20. Security document and/or value document according to claims 14 through 19, characterized by, that the analyzer zones (5, 6) of the verification window (2) are embodied such that they are separated into two adjacent windows.

21. Security document and/or value document according to claim 1, characterized by, that the verification element (2) and the safety feature (3) of the document (1) are, for the purpose of verifying the safety feature, brought into position over each other by folding the document (1), in which effective position they can be machine-recognized.

22. Security document and/or value document according to claim 1, characterized by, that the verification element (2) of a document (1) and the safety feature (3) of another document (1) are brought into position over each other for the purpose of verifying the security feature.
